(19) United States
(12) Patent Application Publication
(10) Pub. No.: US 2026/0209588 A1
(43) Pub. Date: Jul. 23, 2026

(54) A FILLER COMPOSITION

(71) Applicant: ORION ENGINEERED CARBONS GMBH, Eschborn (DE)

(72) Inventors: Hauke WESTENBERG, Brühl (DE); Michael STANYSCHOEFSKY, Hürth (DE)

(21) Appl. No.: 19/140,192

(22) PCT Filed: Nov. 30, 2023
(86) PCT No.: PCT/EP2023/083701

§ 371 Date: Jun. 17, 2025

(30) Foreign Application Priority Data
Dec. 20, 2022 (EP) 22215101.1

(51) Int. Cl. C09K 5/14; B60C 1/00; C08K 3/04; C08K 3/22; C08K 11/00; C08L 23/22; C09J 11/04; C09J 123/22; C10B 53/07; C10B 57/16

(52) U.S. Cl. CPC C09K 5/14; C08K 3/04; C08K 3/22; C08K 11/00; C08L 23/22; C09J 11/04; C09J 123/22; C10B 53/07; C10B 57/16; B60C 1/00; C08K 2003/2296; C08K 2201/001; C08K 2201/005; C08K 2201/006; C08L 2203/202; C08L 2312/00

(57) ABSTRACT

Suggested is a filler composition comprising or consisting of (a) acetylene carbon black, (b) zinc and/or a zinc compound, and optionally (c) ash.

### AREA OF INVENTION

The present invention relates to the area of industrial fillers, particularly for the tire industry and concerns a filler composition comprising acetylene carbon black with improved vulcanization performance, a process for obtaining such composition and various related applications.

### TECHNOLOGICAL BACKGROUND

In tire technology curing means the process of applying pressure to the green tire in a mold to give it its final shape and applying heat energy to stimulate the chemical reaction between the rubber compounds and other materials. The green tire is automatically transferred onto the lower mold bead seat, a rubber bladder is inserted into the green tire, and the mold closes while the bladder inflates. As the mold closes and is locked the bladder pressure increases to let the green tire flow into the mold, taking on the tread pattern and sidewall lettering engraved into the mold. The bladder is filled with a recirculating heat transfer medium, such as steam, hot water, or inert gas. At the end of cure the pressure is bled down, the mold opened, and the tire stripped out of the mold.

A useful component for curing bladder compounds is acetylene carbon black because it imparts a higher thermal conductivity than Furnace Carbon Blacks at similar loadings due to a much higher graphitization degree. This characteristic accelerates the vulcanization process of the green tire, reduces cure times, increases throughput per curing unit and decreases energy consumption in the tire plant.

To obtain the black, acetylene is partly burnt in parallelly operating furnace units. It gets thermally decomposed at very high temperature in each furnace. Afterwards the combustion gases and the acetylene carbon black get separated, densified, and transferred to a bag filter system. Compared to furnace black, as a standard in the carbon black market, Acetylene carbon black convinces by its high purity and hardly any traces of contaminations. These advantages result from acetylene as pure feedstock and its thermal decomposition at very high temperature.

While the lifetime of a conventional tire ranges from 1 to about 10 years, life cycle of bladders is much shorter. Due to such short lifetime and the fact, that a typical bladder composition contains about 50 phr or 30 wt-% acetylene carbon black curing bladders represent an interesting source for the recovery of acetylene carbon black.

### RELEVANT STATE OF THE ART

Pyrolysis of waste tires and waste carcasses of tires is state of the art for long time and subject to a huge number of patent publications, as for example:

EP 0287534 B1 (MARANGONI) offers a system comprising a pyrolysis chamber having a tire carcass inlet port and communicating with at least a duct for supplying combustion air, the pyrolysis chamber further communicating with s steam generator and having a stationary bottom of frustum of cone shaped coaxially communicating with the combustion air duct, rotating arm members being moreover provided, associated with the stationary bottom, adapted to cause waste unburnt material to be discharged from an outlet port formed through the stationary bottom.

EP 0592057 B1 FORMEX) discloses an apparatus and a method for reprocessing crushed organic waste products, such as rubber waste from worn car tires by pyrolysis, the method including pyrolytically decomposing the crushed waste products in a pyrolysis bath which is one of a bed or a bath, and which has a temperature ranging from 450 to 550° C. into a mixture including volatilized constituents, liquid constituents, and solid constituents; collecting at least a part of the volatilized constituents from a gas space above the pyrolysis bath and transporting the collected volatilized constituents away from the pyrolysis bath for further utilization; and introducing a gas intermittently or continuously into the gas space above the pyrolysis bath.

EP 0768345 B1 (MITUBISHI) provides a method for producing carbon black and an apparatus therefor, in which a gasification furnace is separated into a lower gasification section and an upper pyrolysis section via a distribution plate, waste tire chips are supplied to the pyrolysis section of the gasification furnace and pyrolytically decomposed to separate it into pyrolysis gas and fixed carbon, fine fixed carbon is separated from a mixed gas discharged from the gasification furnace and supplied to the gasification section of the gasification furnace to generate gasification gas, the gasification gas is supplied to the pyrolysis section through the distribution plate, a mixed gas of pyrolysis gas and gasification gas is introduced after fine fixed carbon is separated, so that carbon black is yielded.

EP 1114122 B1 (SES) relates to a method for the recovery of carbon and combinations of hydrocarbons from discarded tires or similar polymeric material by pyrolysis, using a reactor in which the material is placed in a largely fragmented condition, whereby the material is heated to pyrolysis temperature by the recirculation of previously formed and heated pyrolysis gas which is led through the material and where the pyrolysis gas obtained in this way is brought to condense to condensable products in a condenser connected to the reactor.

EP 1163092 B1 (METSO) claims a process and system for the recovery of desirable constituent materials from vehicle tire pieces through pyrolysis. The system includes a pyrolysis section that is divided into a plurality of individual heating zones.

EP 1785248 B1 (KRIVORUCHKO) relates to thermally treating hydrocarbon raw material, in particular recycling used tires and makes it possible to increase the efficiency of the hydrocarbon material treatment and reduce the energy costs. The method consists in pyrolyzing shredded tires at a temperature of 550 to 800° C. in a reducing gas medium associated with pyrolysis product separation.

For example, WO 2015 128278 A1 (ORION) discloses a pelleted acetylene carbon black having a mass strength measured according to ASTM D 1937-10 of 200 N at most and an average pellet size measured according to ASTM D 1511-10 of at least 1.0 mm, to the use of any of said pelleted acetylene carbon blacks to produce a compound comprising a resin or polymer or rubber matrix and the acetylene carbon black dispersed in said matrix and to a method for producing such a compound.

### OBJECT OF THE INVENTION

The object of the present invention has been providing an acetylene carbon black composition recovered from curing bladder compounds that shows at least similar, preferably even better curing performance, particularly with respect to thermal conductivity and vulcanization time.

Another object of the present invention has been developing a process for the recovery of acetylene carbon black from curing bladders comprising acetylene black that is sustainable, particularly in the sense, that said recovery emits less carbon dioxide compared to the production of acetylene carbon black from acetylene and the by-products provide additional environmental benefits.

### DESCRIPTION OF THE INVENTION

A first task of the present invention refers to a filler composition comprising or consisting of
(a) acetylene carbon black,
(b) zinc and/or a zinc compound, and optionally
(c) ash.

Ash is generally the residue after treatment of a substance in an oxygen containing atmosphere at elevated temperatures or in other words the amount of inorganic noncombustible material in a sample. For example, Carbon Blacks can be tested by applying a method according to ASTM D 1506-2015.

A characteristic feature of the present invention is the presence of zinc in the filler composition, a component that is found in all curing bladders. Zinc can be present in the form of metallic zinc. In the alternative also zinc compounds can be present, said compounds being selected from the group consisting of zinc oxide, complexes and coordination compounds of zinc and aggregates of zinc and coke particles, and mixtures thereof. Ash may also comprise zinc, for instance in form of zinc compounds. Said zinc compounds may also comprise a content of metallic zinc, for example as a residue from the manufacturing process.

As a matter of fact, for the production of bladders usually acetylene carbon black and a zinc compound—preferably ZnO—are used in order to decrease vulcanization time. Surprisingly, however, the applicant has found that—with equal amounts of acetylene carbon black and zinc and/or a zinc compound used in each case the filler composition according to the invention shortens the vulcanization time even more significantly than the mixtures according to the state of the art containing the carbon black and zinc components separately from each other.

Other advantages of the present invention are that the filler compositions have improved thermal conductivity and have fewer defects when compared with similar compositions.

This is understood to mean inhomogeneities in the composition that reduce the quality of the product. In fact, the filler composition according to the invention can be used without further reprocessing and can readily replace fresh acetylene carbon black—if equal in weight to the proportion of acetylene carbon black in the filler composition.

The production process is also characterized by reduced carbon dioxide emissions compared with the production of fresh carbon black. Also, the gas mixture produced during pyrolysis can be used to generate energy and thus operate the pyrolysis furnace. Compared with other pyrolysis processes, in particular the pyrolysis of used tires, a gas is obtained that contains considerably more hydrogen and smaller amounts of methane and thus has a higher calorific value.

### Filler Compositions

In a preferred embodiment, the filler composition consists
(a) about 60 to about 99.5 wt.-percent, preferably about 75 to about 99.5 wt.-percent, more preferably about 85 to about 99.5 wt. acetylene carbon black,
(b) about 0.2 to about 10 wt.-percent, preferably about 0.4 to about 8 wt.-percent of said zinc and/or zinc compound and optional
(c) about 0.5 to about 15 wt.-percent, preferably about 1 to about 12 wt.-percent ash,
   on condition that the amounts add to 100 wt.-percent. For the sake of good order, it is emphasized that compositions yielding more than 100 or less than 100 wt.-percent are not covered by the invention. Based on the information provided in the specification a skilled person can easily identify compositions which sum up to 100 wt.-percent without any further investigation.

In the sense of the present invention the term ash refers to solid pyrolysis and/or coking products, which are different from carbon black, particularly various salts. Said zinc compound can be selected from the group consisting of metallic zinc, zinc oxide, complexes and coordination compounds of zinc and aggregates of zinc and coke particles, and mixtures thereof.

In another preferred embodiment the compositions show characteristic surface areas and filler structures
a BET surface ranging from about 25 to about 200 m²/g; and/or
an OAN ranging from about 80 to about 400 ml/100 g.
   Wherein the BET surface area is determined in accordance with ASTM D 6556-2021 and the Oil absorption number (OAN) in accordance with ASTM D2414-2022.

In another preferred embodiment the filler composition consists of a ground material having a particle diameter not larger than 15 μm. The particle size is analyzed by laser diffraction according to ISO 13320:2020.

Also claimed is a filler composition obtainable or obtained by the following steps:
(a) providing curing bladders;
(b) subjecting said bladders to pyrolysis to obtain a product mixture consisting of a solid residue, an oil and a gas fraction;
(c) removing the oil and the gas phase from the solid residue; and
(d) grinding and/or pelletizing the solid residue.

### Manufacturing Process

Also claimed is a process for manufacturing a filler composition comprising or consisting of the following steps:
(a) providing curing bladders, said curing bladders comprising acetylene black;
(b) subjecting said bladders to pyrolysis to obtain a product mixture consisting of a solid residue, an oil and a gas fraction;
(c) removing the oil and the gas phase from the solid residue; and
(d) grinding and/or pelletizing the solid residue of step (c).

A thermal decomposition of organic matter in the absence of oxygen is called pyrolysis. During pyrolysis, polymer chains and cross-links are broken up and disintegrate into shorter fragments. These in turn can restructure depending on the chemical constituents and structure of the molecules. The main gases emitted are CO₂, CO, H₂, CH₄ and various hydrocarbons. In addition to the remaining solid residue, an oil vapor mixture is formed. Condensable fractions occur as pyrolysis oil, whereas non-condensed fractions are present as pyrolysis gas. Thus, the three material groups pyrolysis coke, pyrolysis oil and pyrolysis gas are formed. The process temperature and the heating rate are decisive for their composition and distribution.

Thermal decomposition of the rubber material starts typically at a temperature of 270° C. During pyrolysis, the polymer chains are broken up and disintegrate into shorter fragments; random fragmentation occurs as a result of heat exposure. Fragments of variable, average length are formed, with decreasing length as temperature increases. At low temperatures, mainly kerosene, olefins and aromatics are formed. In contrast, at higher temperatures, light oils and gases such as hydrogen, methane and heavy hydrocarbons are formed. Due to the use of carbon black in most rubber compounds, a solid residue is obtained even at complete decomposition. Higher decomposition temperatures favor the formation of pyrolysis gas accompanied by a reduced oil yield. The product distribution shifts with increasing temperature and heating rate in favor of the gas yield and the H₂ concentration. Detailed information about pyrolysis procedures can be found in EP 2427533 B1 and EP 2661475 B1 (both assigned to PYRUM INNOVATIONS).

Having said this, pyrolysis is preferably conducted at a temperature ranging from about 300 to about 1.000° C. and preferably from about 400 to about 650° C. It is preferred to raise temperature with a rate of 100° C./15 minutes, until the maximum temperature is reached. Typically, pyrolysis is complete after 30 to 100 minutes, however it is recommended to continue the process at the high temperature for another 100 to 250 minutes to make sure that all volatiles have been outgassed. The solid residue can be separated off from the pyrolysis oil for example by filtration, followed by a washing and drying step. The pyrolysis gas is led to a furnace and burned to generate energy for heating the pyrolysis oven.

### INDUSTRIAL APPLICATION

Another object of the present invention refers to a compound comprising or consisting of
(a) at least one synthetic and/or natural vulcanizable rubber or polymer and
(b) the filler composition as described above.

In a first preferred embodiment the compound shows
a thermal conductivity at 25 or 150° C. ranging from about 0.15 to about 0.5, preferably from about 0.15 to about 0.4 and more preferably from about 0.2 to about 0.375 W/(m*K).
Thermal conductivity should be determined according to ASTM E 1461-2011.

In another preferred embodiment the compound shows a Surface Topography (TOPO) of the cut specimen of less than 2%, more preferably between 0.2 and 1.5% and most preferably between 0.1 and 1.4%. TOPO is a measure for filler dispersion determined by means of surface topography, inclusive of Medalia correction, according to the procedure described in A. Wehmeier, “Filler Dispersion Analysis by Topography Measurements”, Technical Report TR 820, Degussa GmbH as well as in A. Wehmeier, “Entwicklung eines Verfahrens zur Charakterisierung der Füllstoffdispersion in Gummimischungen mittels einer Oberflachentopographie”, Thesis, 1998 at the Monster University of Applied Sciences, and DE 199 17975 C2.

Also claimed is a method for shortening vulcanization time in the production of rubbers, tires and/or curing bladder compounds, comprising, or consisting of the following steps:
(a) providing a vulcanizable rubber or a blend of vulcanizable rubbers or polymers;
(b) adding the filler composition as defined above;
(c) and subjecting the mixture of step (b) to vulcanization; and optionally (d) molding the vulcanization product to obtain a curing bladder or other rubber articles.

### Vulcanizable Rubbers and Polymers

The term “vulcanizable rubber composition” refers to a composition of a rubber component optionally with various further ingredients conventionally used in the art of rubber compounding that can be cured by vulcanization under formation of a vulcanizate. The terms “curable” and “vulcanizable” are used interchangeably throughout this description unless otherwise stated and refer to a chemical reaction linking polymer chains to each other by means of a cross-linker or vulcanizing agent.

The vulcanizable rubber component suitable for use in the vulcanizable rubber composition can comprise one or more gums containing olefinic unsaturation, i.e., diene-based rubbers or elastomers. The terms “rubber” and “elastomer” may be used interchangeably throughout this description unless otherwise stated. The rubber component may also comprise a mixture of the rubber containing olefinic unsaturation with other polymer materials containing no such unsaturation as for example thermoplastic or thermoset polymers or the like. Preferably, however, the rubber component only comprises one or more rubbers containing olefinic unsaturation. The phrases “rubber containing olefinic unsaturation” and “diene-based rubber” are used interchangeably and are intended to include both natural and synthetic rubbers or mixtures thereof.

Natural rubber can be used in its raw form and in various processed forms conventionally known in the art of rubber processing. Without being limited thereto, synthetic diene-based rubber may be any rubber containing at least one diene-based monomer that alone or with other monomers constitutes the rubber. Exemplary diene-based rubber materials suitable in the practice of the invention include, but are not limited to natural rubber, emulsion-styrene-butadiene rubber, solution-styrene-butadiene rubber, polybutadiene, polyisoprene, ethylene-propylene-diene rubber (EPDM), butyl rubber and halogenated butyl rubber, acrylonitrile-butadiene rubber, hydrogenated acrylonitrile-butadiene rubber, polychloroprene, or any combination thereof. The rubber composition according to the present invention can also comprise one or more non-diene-based rubber materials. Exemplary nondiene-based rubber materials suitable in the practice of the invention include, but are not limited to, ethylene-propylene rubber (EPM), chlorinated polyethylene, chlorosulfonated polyethylene, acrylate rubber, ethylene-vinylacetate rubber, ethylene-acrylic rubber, epichlorohydrin rubber, silicone rubber, fluorosilicone rubber, fluorocarbon rubber or any combination thereof. Suitable rubbers also include functionalized rubbers and rubbers coupled to silicon or tin. For example, rubbers can be functionalized with functional groups like amine, alkoxy, silyl, thiols, thioesters, thioether, sulfanyl, mercapto, sulfide or combinations thereof. The one or more functionalities can be primary, secondary or tertiary and can be located at one or both chain ends (e.g. alpha,omega-functionalization), pendant from the polymer backbone and/or provided within the chain of the polymer backbone. The rubber according to the invention can also be partially cross-linked. Thus, prior to use in the vulcanizable rubber composition, part of the polymer chains of the rubber material can be cross-linked either by means of a coupling agent or without. The polymeric material can furthermore be supplied in any form, typically however as bales or chips.

Preferably, the rubber component comprises a mixture of natural and synthetic diene-based rubbers. A non-limiting specific rubber material that can be used in the practice of the present invention is for example Butyl 301 and Baypren® 110.

The vulcanizable rubber composition may comprise the filler composition according to the present invention in an amount of 5 to 100 phr such as of 10 to 70 phr. As used herein, the term “phr” refers to parts by weight of the recited respective material per 100 parts by weight of rubber or elastomer.

The vulcanizable rubber composition according to the present invention optionally may further comprise at least one vulcanizing agent able to induce cure of the rubber. Possible vulcanizing agents include any vulcanizing agents known from the art such as phenol resins.

The vulcanizable rubber composition may further comprise one or more further filler materials such as for example other carbon blacks, silica, organo-silica, carbon nanotubes, carbon fibers, graphite, metal fibers or the like. Carbon blacks useful in this respect can be exemplified by the ASTM-grade carbon blacks selected from the 100er to the 900er series as classified according to ASTM D1765. For curing bladders it is highly recommended to use acetylene black instead of furnace blacks. Acetylene blacks increase the thermal conductivity of the compound.

The vulcanizable rubber composition according to the invention may further comprise other commonly known additives. Such additives include, for example, curing aids such as primary and secondary vulcanization accelerators, activators, and pre-vulcanization inhibitors, processing additives such as oils, resins in form of tackifying resins and plasticizers, softeners, fillers, waxes, peptizing agents and antiaging agents such as antioxidants and anti-ozonants. Useful as primary and secondary vulcanization accelerators are for example guanidines, b dicarbamates, dithiocarbamates, thiurams, thioureas, 2-mercaptobenzothiazole, benzothiazole sulfonamides, aldehydeamines, amines, disulfides, thiazoles, xanthates, and sulfenamides. As specific examples it may be referred for instance to N-tert.-butyl-2-benzothiazyl sulfenamide commercially available under the tradename Rhenogran TBBS-80 from Rhein Chemie Additives and diphenyl guanidine commercially available as Rhenogran DPG-80 from Rhein Chemie Additives. Suitable activators include combinations of zinc oxide or the like with a fatty acid like stearic, lauric, palmitic, oleic or naphthenic acid. Primary accelerators can be present in the composition in a total amount ranging from 0.05 to 4 phr. Secondary accelerators are typically employed in smaller amounts than primary accelerators and can be present in the composition in an amount ranging from 0.05 to 3 phr.

Further rubber compounds can be resin cured like in the formulations used in the experimental part of this document. A typical resin based on octlyphenol and formaldehyde to cure butyl rubber is SP 1045 from Safic-Alcan.

The filler composition according to the present invention can be advantageously used for producing compounds comprising a polymeric matrix having the acetylene carbon black dispersed therein. Beside rubbers and elastomers, also other organic resins, polymers and can be used as matrices. Of course, said vulcanized rubber and elastomer are particularly useful for making final products such as tires and curing bladders

The filler composition according to the present invention can be compounded and dispersed in the above-described resin, polymer or rubber matrices using standard mixer and blenders and also might be heated to ease homogeneous dispersion if permitted dependent on the selection of resin, polymer or rubber system, whereby blenders, mixers, kneaders or single-screw or twin-screw extruders as known to a person skilled in the art can be employed.

### Additional Applications

The filler composition of the present invention, optionally after grinding, granulation or forming of pellets, thereby functions in the polymer or rubber to impart electrical and thermal conductivity. Thus, the composition can also be used as an electrically conductive agent for a battery, such as a primary battery, secondary battery, a fuel battery or a compensator. It can also be used as an antistatic agent or as an electrically conductive agent for electrically conductive paper. The filler composition according to the present invention is particularly suitable for the production of semi-conductive shields for wire and cable applications. Furthermore, it can also be advantageously used in coating applications. Therefore, another object of the present invention is directed to the use of the filler composition as an additive in the production of
batteries;
adhesives and sealants; and
conductive compounds, wires and cables.

The process can comprise before mixing the vulcanizable rubber component with the filler composition, a step in which the vulcanizable polymer component is plasticized, for example, by means of agitation. To this end, the vulcanizable rubber component can be provided in an eligible instrument, such as an internal mixer, and can be agitated for 2 minutes or less, such as for 1 minute or less, such as for 45 seconds. Subsequently, the filler composition and potential further optional components can be added to the plasticized vulcanizable rubber component and can be mixed together as disclosed above.

Mixing can be carried out using techniques and instrumentation conventionally known in the art of rubber processing. Mixing can be achieved, for example, by a mixer, a stirrer, a mill, a kneader, a machine using ultrasound, a dissolver, a shaker mixer, rotor-stator dispersing assemblies, or high-pressure homogenizers or a combination thereof. Preferably, a mixer with intermeshing or tangential rotor geometry is utilized.

Mixing can include, if needed, heating the components of the mixture to temperatures above the room temperature. Preferably, however, mixing is carried out without providing extra heat to the mixture beside the heat which may be generated by the agitation process itself.

After the first mixing step, the resulting mixture can immediately be subjected to the second mixing step or can be stored in between the two steps. The mixture can for example be allowed to stand for a few minutes to months, such as for at least 60 minutes, or for at least 12 hours. Prior to the second mixing step, the mixture can be transferred to another mixing chamber and/or to another site, such as for example to a customer.

After the first, or if present, the second mixing step, the process for preparing a vulcanizable rubber composition further preferably comprises a step of an vulcanization agent, and, if needed, one or more activators, one or more accelerators and further components conventionally used in the art of rubber compounding as mentioned above to the mixture. Subsequently, the composition is preferably mechanically agitated in order to achieve at least partial or preferably complete mixing of the composition. The mixing is typically carried out at temperatures residing between 10° C. and 140° C., more typically between 80° C. and 120° C., under constant agitation for less than 5 min, such as less than 3 min. The conditions, especially the rotor speed, can be chosen such that the temperature of the mixture containing the curing agents resides below 110° C.

Further, the vulcanization agents can alternatively be incorporated on an open two-roller mill instead of incorporation in an internal mixer.

The present invention will now be described in more in detail in the following examples. Particularly the measuring methods for the specific acetylene carbon black properties as described above as well as defined in the claims are measured as given below in the experimental part.

### EXAMPLES

### Example 1

### Pyrolysis of Curing Bladders

To obtain a feedstock for the pyrolysis a curing bladder model compound was prepared by using recipe from Table 1. The rubber compounds were mixed in a 2-stepped mixing process. A GK1.5E mixer from Werner and Pfleiderer was used having a chamber volume of 1.58 l with intermeshing mixing rotors. The rotor speed was 45 rpm and the chamber temperature was 60° C.

TABLE 1
Bladder compound

| Composition of the bladder compound | Amount (phr) |
|---|---|
| Butyl 301 | 95 |
| Baypren 110 | 5 |
| Acetylene Black | 50 |
| ZnO | 5 |
| Process Oil P 100 | 5 |
| SP 1045 | 9 |

In the rubber-chemical industry, parts per hundred rubber (phr) refers to the mass fractions of the individual compound components in a recipe for an elastomer compound. These figures are based on 100 (mass) parts of the base polymer or the base polymers (in the case of polymer blends)

Information on components:
Butyl 301 (Butyl rubber, IIR) and Baypren 110 (Chloroprene rubber, CR) from Arlanxeo Deutschland GmbH,
Acetylene black was Y200 BDS from Orion Engineered Carbons GmbH
Process Oil P 100 from Schill und Seillacher.
ZnO from Arnsperger Chemikalien GmbH
SP-1045 octylphenol resol based curing resin from Safi-Alcan

The chloroprene rubber and the butyl rubber were mixed for 1 min and 35 phr of filler were added. After 90 s the ram was lifted and swept and the remaining 15 phr of CB and the process oil was added and mixed for further 90 s. After another ram lift and ram sweep the mixing was continued for another 90 s. After that the compound was dropped, cooled, and sheeted on an open mill. It was secured that the mixing temperature didn't exceed 160° C.

The compound was allowed to rest overnight, and then the phenolic resin SP-1045 was incorporated into the mixture on an open mill. The mixing temperature was controlled by keeping it below 110° C.

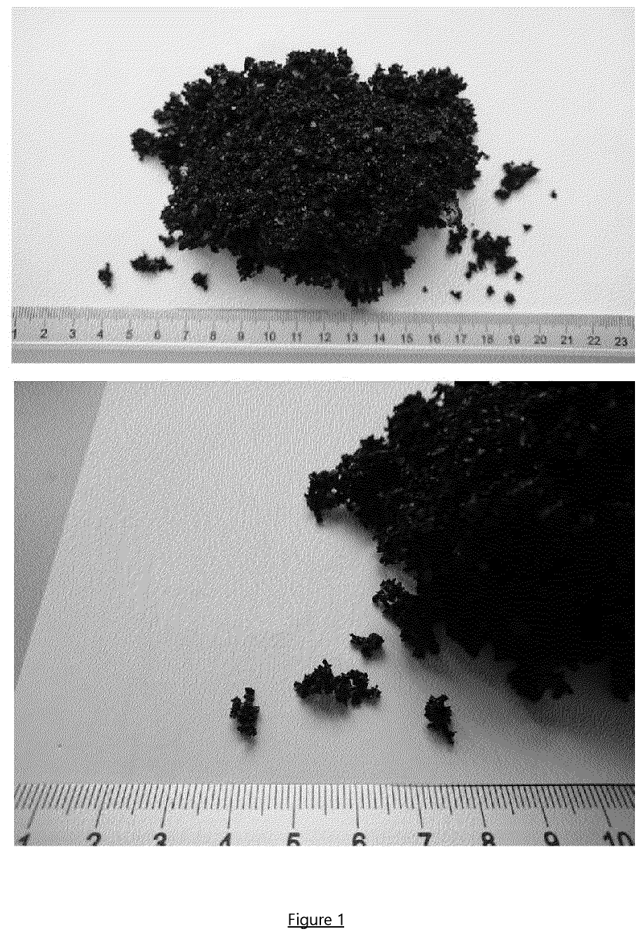

After that 2 mm thick rubber sheets were cured for 30 min at a temperature of 190° C. The sheets were then shredded into small pieces of about 1 to 5 mm (FIG. 1) for the pyrolysis operation.

The pyrolysis test was carried out in a laboratory plant with a reactor volume of 1 L and a heating power of 1 kWₑₗ. The material was placed in a pyrolysis reactor for example as disclosed in EP 2427533 B1 and inerted together with the plant components. Subsequently, the material was slowly heated up to the target temperature, so that a slow decomposition of the material took place. Before the start of the experiment, a defined quantity of the rubber granulate was added to the reactor and, after attachment, inerted together with all piping with nitrogen from a pressurized gas cylinder. For this purpose, nitrogen was first added and then discharged via ball valves. The experiment was started with heating of the reactor. The temperature of the insulated reactor was increased and maintained at the set point by means of a heating coil, controlled by a temperature sensor inside the reactor. The pyrolysis gas released during pyrolysis was cooled down to 5° C. in heat exchangers. During this process, portions with sufficiently low vapor pressure condensed out and precipitated in a laboratory bottle as pyrolysis oil. The non-condensed portions of the pyrolysis gas were drawn by a fume hood over a coalescing filter to remove any aerosols.

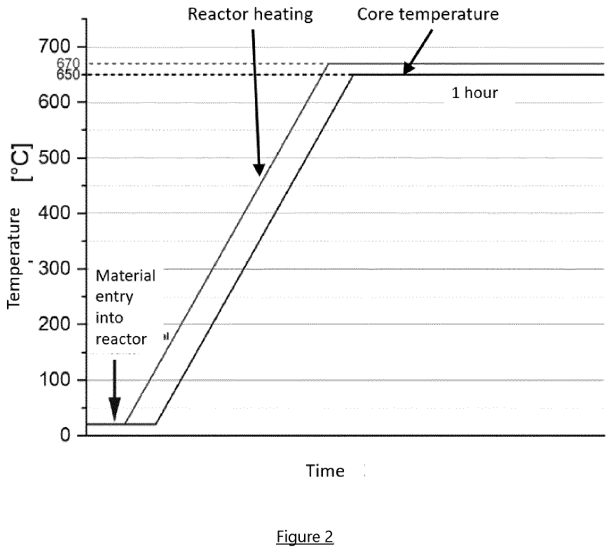

Basic tests were carried out with the addition of material to the reactor before the start of the test and subsequent heating of the reactor together with the sample material. The target temperature of the pyrolysis was 650° C. with a residence time of one hour. FIG. 2 shows the general course of a basic experiment with respect to the applied reactor temperature and the desired core temperature. The starting material was fed into the cold reactor and, after inerting, was continuously heated up to a target temperature of 650° C. The target temperature of the pyrolysis reactor was determined for this purpose. A reactor target temperature of 670° C. was selected for this purpose. Once the target temperature had reached, it was maintained for 1 hour to ensure that the pyrolysis reaction is complete.

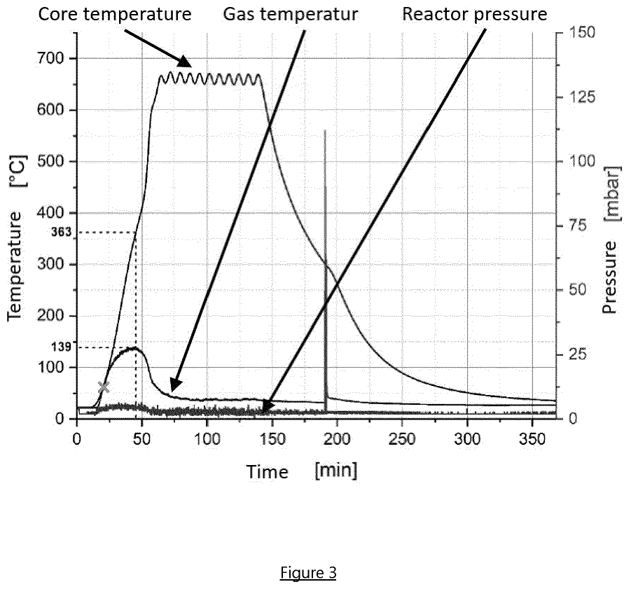

The temperature curve of the core temperature and the outflowing gas (before cooling by the heat exchanger) as well as the change in pressure over time are shown as an example in FIG. 3. Here, a simultaneous increase in core temperature and gas temperature can be seen, indicating an early onset of thermal decomposition. It should be noted here that the material temperature near the reactor wall is always above the core temperature when heated. A visible formation of a white mist was observed at a core temperature of 33° C. and a wall temperature of 109° C., which can be partly attributed to the evaporation of water. At a core temperature of 61° C. and a wall temperature of 220° C., condensation of pyrolysis oil was observed.

With further heating, the temperature of the escaping gas continued to rise until it reached a maximum of 139° C. at a core temperature of 363° C. after a total of 49 minutes. Subsequently, after reaching a material temperature of 650° C., the gas temperature dropped to 60° C. and remained constant until the reactor heater was turned off. This drop in gas temperature indicates the completion of the pyrolysis reaction at hand. After reaching a material temperature of 650° C., this was held for 1 hour to remove volatiles as well as adsorbed oil residues from the pyrolysis coke to ensure complete pyrolysis. Over the entire course of the test, the reactor pressure was almost constant. Only a slight increase from 3 mbar to 5 mbar was observed during oil condensation. The pressure increase to 112 mbar after 180 minutes was caused by the introduction of nitrogen to purge the system. Table 2 shows the associated mass balances of the tests performed. The proportion of pyrolysis gas was determined by calculation.

TABLE 2
Mass balances of the test series

| | Entry | Solid residue | | Pyrolysis oil | | Gas |
|---|---|---|---|---|---|---|
| No | m [g] | m [g] | ζ Ma-% | m [g] | ζ Ma-% | ζ Ma-% |
| 1 a | 202.86 | 74.33 | 36.64 | 20.95 | 10.33 | 53.03 |
| 1b | 256.31 | 94.43 | 36.84 | 53.80 | 20.99 | 42.17 |
| 1c | 252.22 | 93.28 | 36.98 | 50.62 | 20.07 | 42.95 |
| 1d | 256.69 | 94.58 | 36.85 | 52.48 | 20.44 | 42.71 |
| 1e | 298.51 | 110.94 | 37.16 | 53.36 | 17.88 | 44.96 |
| 1f | 350.00 | 131.77 | 37.65 | 71.25 | 20.36 | 41.99 |
| 1g | 269.42 | 100.71 | 37.38 | 52.81 | 19.60 | 43.02 |
| 1h | 237.88 | 88.06 | 37.02 | 44.85 | 18.85 | 44.13 |
| Total | 2123.89 | 788.1 | 37.1 | 400.12 | 18.6 | 44.4 |

The majority of the rubber compound was converted into pyrolysis gas with an average share of 44.4%. With an average share of 37.1%, the solid residue (“pyrolysis coke”) represented the second largest fraction. The formation of pyrolysis oil averaged 18.6%.

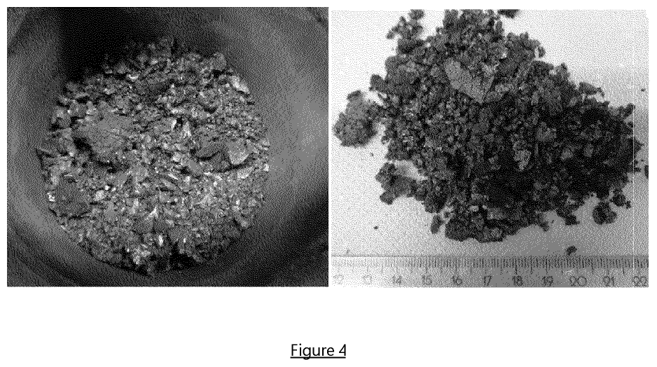

The solid residue containing acetylene carbon black, ash, zinc and coking products, was obtained in the form of a black porous solid (FIG. 4). The material was largely free-flowing and could be removed from the reactor without difficulty. After combining the solid residues from all tests to produce a representative sample, the material was ground in an impact mill to avoid particles having a diameter larger than 15 μm.

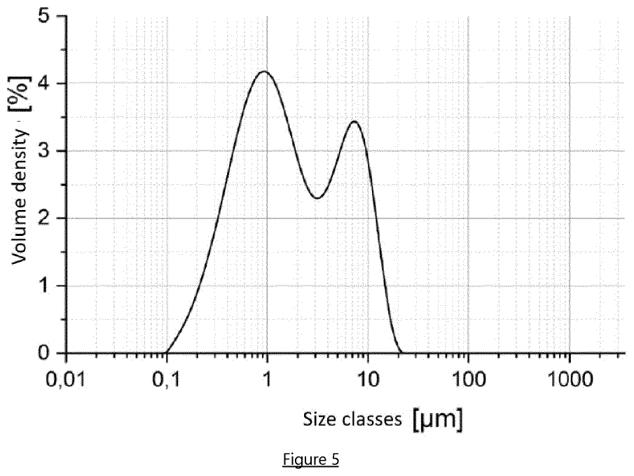

Table 3 shows the results of the particle size measurements of the ground solid residue. The yield of the grinding was 52%. A total of 390 g of the ground solid residue could be produced. The average particle size distribution is also shown graphically in FIG. 5.

TABLE 3
Particle size distribution of the ground solid residue. The particle
size was analyzed by laser diffraction according to ISO 13320: 2020.

| Batch | Dₓ (10) | Dₓ (50) | Dₓ (90) | Dₓ (95) | Dₓ (97) |
|---|---|---|---|---|---|
| A | 0.39 | 1.54 | 9.73 | 12.2 | 13.9 |
| B | 0.40 | 1.60 | 9.23 | 11.5 | 12.9 |
| C | 0.41 | 1.64 | 9.36 | 11.7 | 13.1 |
| Average | 0.40 | 1.59 | 9.46 | 11.8 | 13.3 |

The pyrolysis oil obtained was in the form of a dark brown, low viscosity liquid with a pungent sulfur-like odor. After a longer standing time, the formation of a second phase in the form of a colorless and clear liquid was observed. This was most likely process water, which is typically formed during the pyrolysis of rubber.

With regard to the composition of the pyrolysis gas, it is clear that hydrogen is the main component with an average share of 42.6 vol %. The second largest component is methane with 16.7 vol %, followed by nitrogen with 5.7 vol %. Oxygen, carbon monoxide, and carbon dioxide each accounted for less than 2 vol %. In comparison with the gas composition to the pyrolysis gas during the conversion of used tires, a significantly higher hydrogen content and thus a correspondingly higher calorific value was found.

### Analytical Data of the Sample Materials

The properties of the sample material according to the invention also referred to as filler composition, recovered acetylene black or rAB are summarized in Table 4:

TABLE 4
Properties of the recovered acetylene black (rAB)

| Properties | Unit | rAB1 |
|---|---|---|
| BET surface area (ASTM D-6556-19a) | m²/g | 43 |
| STSA surface area (ASTM D-6556-19a) | m²/g | 40 |
| OAN (ASTM D-2414-21) | ml/100 g | 138 |
| Toluene transmittance [425 nm] (ASTM D1618-18) | % | 95.8 |
| pH-value (ASTM 1512-21) | | 7.01 |
| Ash content (ASTM D 1506: 2015) | wt % | 7.89 |
| Carbon (DIN 51732: 2014-07) | wt % | 91.03 |
| Hydrogen (DIN 51732: 2014-07) | wt % | 0.38 |
| Nitrogen (DIN 51732: 2014-07) | wt % | 0.09 |
| Sulfur (DIN 51732: 2014-07) | wt % | 0.03 |
| Zinc (ASTM D8371-20) | wt % | 5.9 |

### Measurements of Properties

BET BET surface area has been measured according to ASTM D-6556-19a.

STSA surface area has been measured according to ASTM D-6556-19a.

OAN structure is measured according to ASTM D-2414-21.

Toluene transmittance [425 nm] is measured according to ASTM D1618-18.

pH-value is measured according to ASTM 1512-21.

Ash content is measured according to ASTM D 1506:2015.

Carbon, Hydrogen, Nitrogen and Sulfur content is measured according to DIN 51732:2014-07.

Zinc content is measured by inductively coupled plasma—optical emission spectrometry (ICP OES). A pressure-assisted microwave digestion was carried out before for instance by using a micro-wave and nitric acid. The measurements were carried out according to ASTM D8371-20.

### In-Rubber Testing of the Recovered Acetylene Black

In the following study the in-rubber properties of the rAB (recovered acetylene black, filler composition) according to the invention were compared against the ones of virgin acetylene black, recovered carbon black from end-of-life tires and virgin standard furnace blacks.

The rubber compounds were prepared in a 2-stepped mixing process. A HAAKE™ Rheomix kneader having a chamber volume of 0.379 l and tangential mixing rotors were used. The rotor speed was 50 rpm and the chamber temperature was 65° C. The chloroprene rubber and the butyl rubber were mixed for 1 min and then 70 wt % of the filler and the ZnO were added. After 90 s the ram was lifted and swept, and the remaining 30 wt % of filler and the process oil were added and mixed for further 90 s. After another ram lift and ram sweep the mixing was continued for another 90 s. After that the compound was dropped and cooled and sheeted on an open mill. It was made sure that the mixing temperature didn't exceed 160° C. The compound was allowed to rest overnight, and then the phenolic resin was added on an open two-roller mill. It was made sure that the mixing temperature didn't exceed 110° C. Vulcanizates were cured for 30 min at a temperature of 190° C.

### Example 2

### Rubber Properties

Six different rubbers were prepared and subjected to vulcanization. The compositions of the rubbers are provided in Table 5:

TABLE 5
Rubber compositions. The raw material concentration is reported as phr.

| | Samples | | | | | |
|---|---|---|---|---|---|---|
| | C1 | C2 | C3 | C4 | C5 | C6 |
| Components | N660 | N330 | AB | AB ZnO adjusted | rCB | rAB |
| Butyl 301 | 95 | 95 | 95 | 95 | 95 | 95 |
| Baypren 110 | 5 | 5 | 5 | 5 | 5 | 5 |
| Corax N660 | 50 | | | | | |
| Corax N330 | | 50 | | | | |
| Acetylene black (virgin) | | | 50 | 46.1 | | |
| rCB (from ELT) | | | | | 50 | |
| Recovered acetylene black | | | | | | 50 |
| according to invention | | | | | | |
| ZnO | 5 | 5 | 5 | 8.9 | 5 | 5 |
| Process Oil | 5 | 5 | 5 | 5 | 5 | 5 |
| SP 1045 | 9 | 9 | 9 | 9 | 9 | 9 |

Information on components:
Butyl 301 (IIR rubber) and Baypren 110 (Chloroprene rubber) from Arlanxeo Deutschland GmbH,
CORAX® N660 and CORAX® N330 from Orion Engineered Carbons GmbH.
rCB ReOil RB 615 from Reoil Sp. z o.o.
Acetylene black (virgin) AB was Y200 BDS from Orion Engineered Carbons GmbH
SP-1045 octylphenol resol based curing resin from Safi-Alcan
PROCESS OIL P 100 from Schill und Seillacher.
ZnO from Arnsperger Chemikalien GmbH

Hardness was measured according to DIN 53505:2000-08.

Tensile strength, elongation at break, Modulus 100%, Modulus 200%, Modulus 300% and Modulus 500% were measured according to DIN 53504:2017-03.

The curing of the rubber compositions was followed by measuring the change of torque over curing time with a moving-die-rheometer (MDR 2000E) following ISO 6502-3:2018.

Tear Resistance was measured according to DIN ISO 34-1:2016-09, method B, variant (b) using an angle test specimen with notch, measuring the force required for enlargement of the preformed notch.

Thermal conductivity was determined according to ASTM E 1461-2011.

TOPO is a measure for filler dispersion determined by means of surface topography, inclusive of Medalia correction, according to the procedure described in A. Wehmeier, “Filler Dispersion Analysis by Topography Measurements”, Technical Report TR 820, Degussa GmbH as well as in A. Wehmeier, “Entwicklung eines Verfahrens zur Charakterisierung der Füllstoffdispersion in Gummimischungen mittels einer Oberflachentopographie”, Thesis, 1998 at the Monster University of Applied Sciences, and DE 199 17975 C2.

The two carbon black grades CORAX® N660 and N330 are conventional furnace carbon blacks of the applicant, which differ mainly in their specific surface area and structure. The product rCB (recovered carbon black) is a filler composition obtained by pyrolysis of passenger car and truck tires and, like the other two examples, is used for comparison. The filler composition rAB (recovered acetylene black) is according to the invention and was obtained by pyrolysis of a curing bladders compound.

The product rAB contains 5.9 wt.-percent zinc. To take this into account the amount of Y200 BDS and zinc oxide were therefore adjusted accordingly in C4 having virgin acetylene black. That means the compound C4 has increased ZnO concentration and decreases acetylene black concentration in comparison to C3, but similar zinc and acetylene concentrations compared to C6. The properties of the six rubbers are shown in Table 6.

The comparison of C1 (N660) and C2 (N330) teaches that the compound thermal conductivity is independent of the specific surface area. N660 has a specified STSA of 34 m²/g and the N330 has an STSA which is more than double 76 m²/g. However, compounds with equal amounts of N330 and N660 have very similar thermal conductivity Table 6. Ce and C2 exhibit also lower thermal conductivities compared to C6, which has the filler composition rAB according to the invention.

Compound C4 (AB and ZnO adjusted) has an intentionally lower amount of acetylene black and higher amount of Zn-substances compared to C3 (AB). C4 was produced to study the influence of lower acetylene black and higher Zn-concentration in butyl rubber. However, if added separately, the decrease in acetylene black and increase in ZnO-concentration doesn't lead to decreased cure times.

Surprisingly, the compound C6 where the Zn-components were combined in the acetylene black filler composition have the lowest cure times tc8 and therefore fastest cure kinetics. This is reflected in the very short tc8 time of only 14.54 m3 and the difference between tc8 and the tc5 of only 13.76 min.

When comparing the compounds including fillers coming from a recycling process C5 with recovered carbon black rCB and C6 with rAB we can conclude the compound comprising the filler composition according to the invention rAB is superior in all aspects which includes dispersion (very low TOPO value), cure kinetics (short tc80), mechanical properties (higher Modulus at 300% elongation, higher tensile strength, higher elongation at break and also higher tear resistance), and thermal conductivity.

TABLE 6
In-rubber properties of the compounds described in Table 5.

| | | | | | C4 | | |
|---|---|---|---|---|---|---|---|
| | | C1 | C2 | C3 | AB | C5 | C6 |
| Property | Unit | N660 | N330 | AB | ZnO adjusted | rCB | rAB |
| MDR 190° C.; tc5 | min | 0.78 | 0.76 | 0.77 | 0.77 | 1.48 | 0.78 |
| MDR 190° C.; tc80 | min | 17.77 | 19.58 | 15.54 | 16.28 | 23.79 | 14.54 |
| MDR 190° C.; tc80-tc5 | | 16.99 | 18.82 | 14.72 | 15.52 | 22.31 | 13.76 |
| TOPO, dispersion, defect area | % | 3.3 | 4.1 | 0.3 | 0.3 | 18.1 | 1.4 |
| Hardness | Shore A | 57 | 64 | 59 | 55 | 51 | 53 |
| Tensile strength | MPa | 12.5 | 15.5 | 12.5 | 13.5 | 9.8 | 12.9 |
| Elongation at break | % | 600 | 570 | 590 | 660 | 570 | 580 |
| Modulus 300% | MPa | 6.3 | 7.3 | 6.9 | 6.0 | 5.0 | 7.1 |
| Tear resistance Graves | N/mm | 22.2 | 25.7 | 23.4 | 22.6 | 18.0 | 21.1 |
| Thermal conductivity 150° C. | W/(m*K) | 0.227 | 0.232 | 0.329 | 0.282 | 0.194 | 0.258 |
| Thermal conductivity 25° C. | W/(m*K) | 0.200 | 0.201 | 0.309 | 0.282 | 0.169 | 0.232 |

What claimed is:

1. A filler composition comprising or consisting of
(a) acetylene carbon black,
(b) zinc and/or a zinc compound, and optionally
(c) ash.

2. The composition of claim 1, consisting of
(a) about 75 to about 99.5 wt.-percent acetylene carbon black,
(b) about 0.2 to about 10 wt.-percent of said zinc and/or zinc compound and optionally
(c) about 0.5 to about 15 wt.-percent ash on condition that the amounts add to 100 wt.-percent.

3. The composition of claim 1 or 2, wherein said zinc and/or zinc compound is selected from the group consisting of metallic zinc, zinc oxide, complexes and coordination compounds of zinc and aggregates of zinc and coke particles, and mixtures thereof.

4. The composition of claims 1 to 3, showing
a BET surface ranging from about 25 to about 200 m²/g; and/or
an OAN ranging from about 80 to about 400 ml/100 g and/or
a particle size smaller than 15 μm.

5. A filler composition obtainable or obtained by the following steps:
(a) providing curing bladder compounds;
(b) subjecting said bladder compounds to pyrolysis to obtain a product mixture consisting of a solid residue, an oil and a gas fraction;
(c) removing the oil and the gas phase from the solid residue; and
(d) grinding and/or pelletizing the solid residue.

6. A process for manufacturing a filler composition comprising or consisting of the following steps:
(a) providing curing bladder compounds;
(b) subjecting said bladder compounds to pyrolysis to obtain a product mixture consisting of a solid residue, an oil and a gas fraction;
(c) removing the oil and the gas phase from the solid residue; and
(d) grinding and/or pelletizing the solid residue of step (c).

7. The process of claim 6, wherein said pyrolysis is conducted at a temperature ranging from about 300 to about 1.000° C.

8. The process of claim 6 or 7, wherein said pyrolysis is conducted over a period ranging from about 30 to about 350 minutes.

9. A compound comprising or consisting of
(a) at least one synthetical and/or natural vulcanizable rubber or polymer and
(b) the filler composition of one of claims 1 to 5.

10. The compound of claim 9 showing
a thermal conductivity at 150° C. ranging from about 0.15 to about 0.5 W/(m*K) and/or
a TOPO defect area of less than 2%.

11. A method for shortening vulcanization time in the production of rubbers, tires and/or curing bladder compounds, comprising or consisting of the following steps:
(a) providing a vulcanizable rubber or a blend of vulcanizable rubbers or polymers;
(b) adding the filler composition of one of claims 1 to 5;
(c) and subjecting the mixture of step (b) to vulcanization; and optionally
(d) molding the vulcanization product to obtain a tire or a curing bladder.

12. The use of the filler composition of claim 1 or claim 6 as an additive in the production of organic resins, polymer, vulcanizable rubbers and/or elastomers, particularly for the production of tires and/or curing bladder compounds.

13. The use of the filler composition of claims 1 to 5 as additive in the production of batteries.

14. The use of the filler composition of claims 1 to 5 as an additive in the production of adhesives and sealants.

15. The use of the filler composition of claims 1 to 5 as an additive in the production of conductive compounds, wires and cables.
